(19) United States
(12) Patent Application Publication
(10) Pub. No.: US 2019/0037822 A1
(43) Pub. Date: Feb. 7, 2019

(54) DEVICE FOR ATTRACTING AQUATIC AND MARINE LIFE

(71) Applicant: Ed Tomlinson, Arvada, CO (US)

(72) Inventor: Ed Tomlinson, Arvada, CO (US)

(21) Appl. No.: 16/048,654

(22) Filed: Jul. 30, 2018

Related U.S. Application Data
(60) Provisional application No. 62/540,231, filed on Aug. 2, 2017.

(51) Int. Cl. A01K 85/00; A01K 85/01

(52) U.S. Cl. CPC A01K 85/005; A01K 85/01

(57) ABSTRACT

A device for attracting aquatic and marine life is disclosed. The device may generate an output in a body of water that simulates the feeding or distress of other aquatic or marine life forms. An example device includes a head coupled to a supply line to provide gas and/or liquid to the head, and an agitator coupled to the head. A plurality of arms of the agitator have a plurality of openings therein to output the gas and/or liquid into a body of water and cause a disturbance. In an example, the agitator sits above, at, or below the surface of a body of water and discharges the gas (or fluid), and/or moves under the influence thereof, to create a disturbance in the body of water, such that desired species of aquatic and marine life are attracted to the disturbance.

### CROSS REFERENCE TO RELATED APPLICATIONS

This application claims the priority benefit of U.S. Provisional Patent Application No. 62/540,231 filed Aug. 2, 2017 for “Device For Attracting Aquatic and Marine Life” of Ed Tomlinson, hereby incorporated by reference in its entirety as though fully set forth herein.

### BACKGROUND

Fish are an important source of calories and nutrients for people throughout the world, and wild-caught fish are generally believed to hold superior value. Flies and lures are based on sight and operate only at very close range limited by the visibility within the water. Net fishing is not always effective either, as fish have quick reflexes and will instinctively retreat from shadows. All of these techniques are ineffective if there are no fish nearby.

While bait and fish attractants based on smell are commercially available, the bait or attractant may lose its odor over time and become less effective or completely ineffective.

Fish “callers” are also commercially available that mimic fish “speech” for attracting a mate. The effectiveness of these devices is questionable, as they may only work during mating season.

More advanced sonar or other technological fish finders can be used to locate aquatic life within a body of water. But these can be expensive and complex to use. Fish finders also have a limited range, and do not work under all conditions. Without a fish finder, fishing can be a time-consuming and random process.

### BRIEF DESCRIPTION OF THE DRAWINGS

FIG. 1 shows an example device for attracting aquatic and marine life.

FIG. 2 is a close up of the example device for attracting aquatic and marine life.

FIG. 3 shows another example device for attracting aquatic and marine life, with weights.

FIGS. 4a and 4b show another example device for attracting aquatic and marine life, with caps.

FIGS. 5a and 5b show another example device for attracting aquatic and marine life, with manifold.

FIG. 6 illustrates a person implementing an example device for attracting aquatic and marine life.

### DETAILED DESCRIPTION

A device for attracting aquatic and marine life is disclosed. In an example, the device may be implemented to generate output (e.g., sound, vibration, and/or light). The output may simulate a fish attractant event, such as an injured fish, a feeding frenzy of small fish, or a swarm of insects. The output may attract larger fish from below, and/or from other areas within a body of water. For example, sound and vibration travel extremely well underwater, and may be detected by fish at much greater distances than lures or bait. Once attracted, these larger fish may notice a baited hook or lure in the vicinity, or come close enough to be ensnared in a net. Thus, the device may be implemented to improve the caught fish yield and/or reduce time expenditures of fisherpeople. The device may be implemented to assist fisherpeople in developed and/or developing countries.

Before continuing, it is noted that as used herein, the terms “includes” and “including” mean, but is not limited to, “includes” or “including” and “includes at least” or “including at least.” The term “based on” means “based on” and “based at least in part on.”

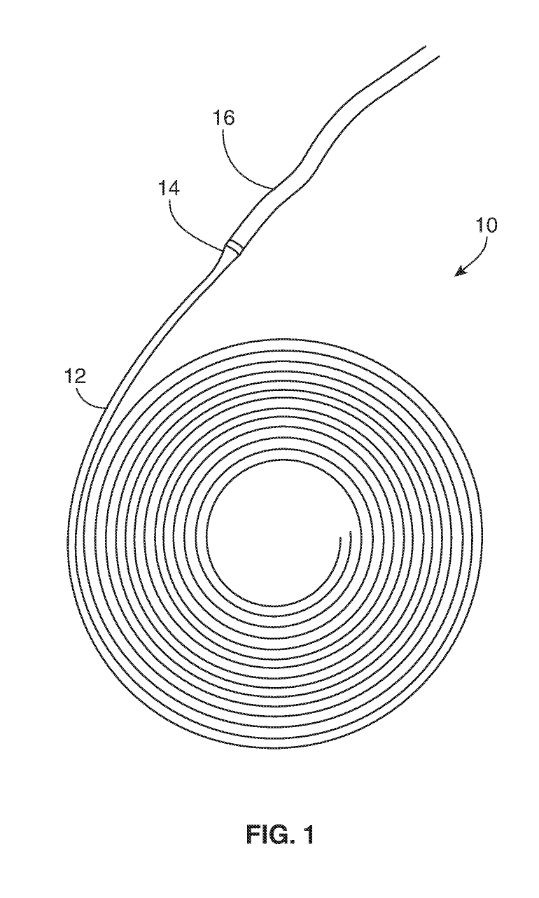

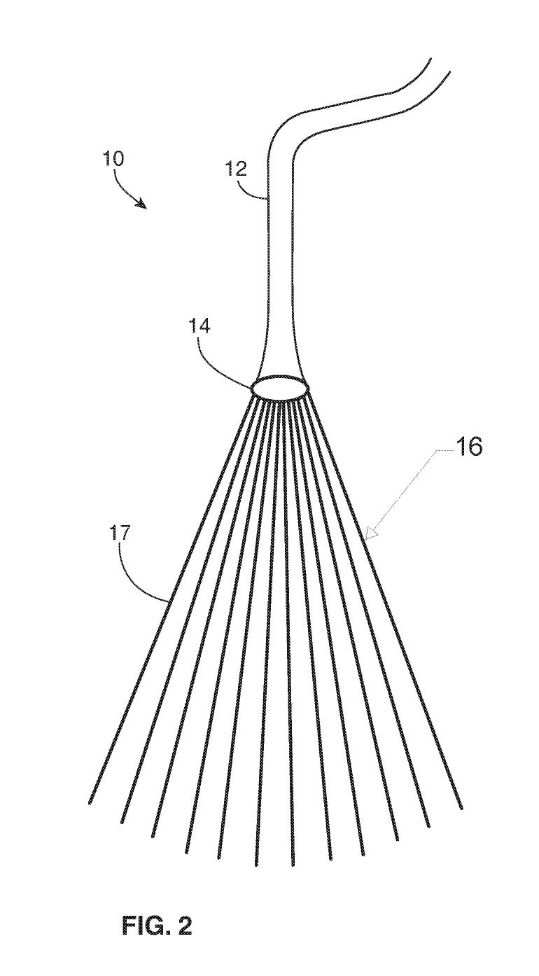

FIG. 1 shows an example device 10 for attracting aquatic and marine life. FIG. 2 is a close up of an example device 10 for attracting aquatic and marine life. In an example, the device 10 for attracting aquatic and marine life includes a supply line 12, a head 14 coupled to the supply line, and an agitator 16 attached to the head. The hose or supply line 12 (depicted as coiled) feeds into a head 14 that is coupled to the supply line 12 on a proximal end.

It is noted that in FIGS. 1 and 2, the distal end is not shown connected to anything in the drawing, but any suitable connection may be provided to connect the supply line 12 to a source of oxygen, air or other gas (or mixture of gases) and/or water or other liquid(s). In an example, a fisherperson may blow into the supply line manually in order to create a flow of gas, but generally this gas flow will be achieved mechanically.

In an example operation, gas flows through the supply line 12 toward the head 14 and into a diffuser or agitator 16. When placed underwater, the diffuser or agitator 16 releases bubbles into the water which may attract the attention of fish and other aquatic or marine life.

In an example, the supply line 12 may be an air hose or other conduit to convey the source (e.g., referred to generally herein as “air, gas and/or fluid”) to the head 14. The head 14 is configured to disperse the supplied air, gas, and/or fluid to the agitator 16. As such, the supply line 12 is operable to provide air, gas, and/or fluid to the agitator 16 and actuate the agitator 16, for example, to stir up water to improve the chances of attracting monitoring, or catching fish and other aquatic or marine life.

In an example, the agitator 16 may include one or more arms 17. In FIG. 1, the arms 17 of agitator 16 are shown in a collapsed position, e.g., for transport and storage. In FIG. 2, the arms 17 are shown spread out. In use, the arms 17 may automatically spread under pressure from the air, gas, and/or fluid discharged through openings (not visible) formed in the arms 17.

It is noted that any size openings may be provided. For example, the openings may be so small so as not to be readily visible to the naked eye, such as the openings in a garden soaker hose. In another example, larger openings may be provided. It is also noted that any number and/or positioning of the openings may be provided on the arms 17 of the agitator 16.

In addition to opening in an outward configuration as shown in FIG. 2, the arms 17 may also move about in response to receiving the supplied air, gas, and/or fluid through the supply line 12, for example, to cause a disruption in the water and thereby simulate a feeding frenzy, injured fish, or the like.

In an example, the agitator 16 may be manufactured from a variety of components, including but not limited to copper, plastic, and rubber. For example, the tubing or arms 17 may be of a smaller diameter than the supply line 12, and include numerous small openings or holes therein through which the air, gas, and/or fluid supplied by the supply line 12 can exit the agitator 16 and into the environment (e.g., into the surrounding water).

In an example implementation, the agitator 16 discharges or “shoots” compressed air and/or water (e.g., when positioned above the water, or floating on or just below the surface of the water) to agitate the water and attract marine/aquatic life to the vicinity. In an example, the device 10 can be configured to agitate water within a diameter of a few inches wide, to a diameter of several feet or more.

Before continuing, it should be noted that the examples described above are provided for purposes of illustration, and are not intended to be limiting. Other devices and/or device configurations may be utilized to carry out the operations described herein.

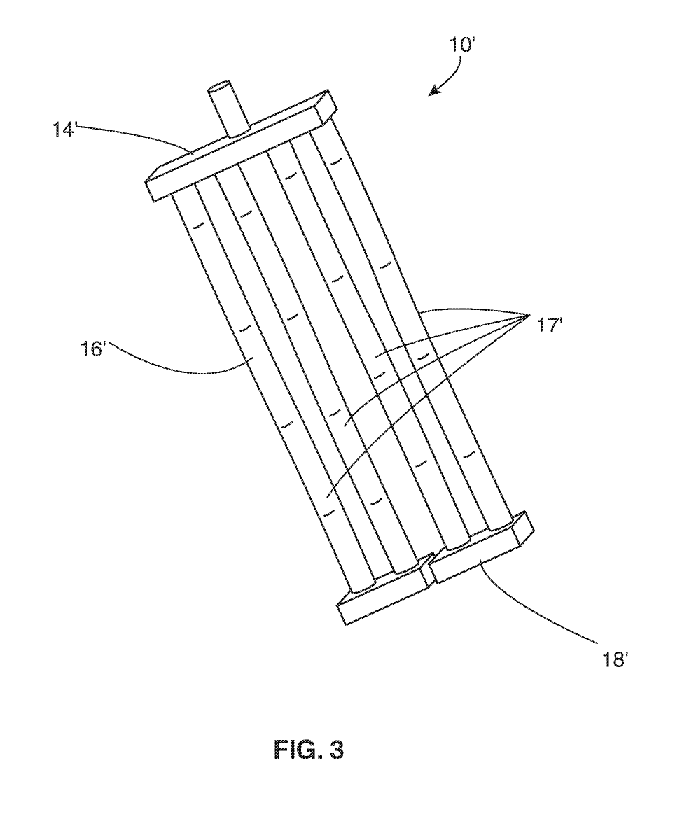

FIG. 3 shows another example device 10′ for attracting aquatic and marine life. Similar components are shown in FIG. 3 with prime (′) reference numbers, and correspond to the reference numbers already described above for FIGS. 1 and 2. It is noted that a supply line (e.g., supply line 12 in FIGS. 1 and 2) is not shown in FIG. 3 to simplify the drawing, but may also be provided as part of, or separate from, the device 10′.

In this example, the agitator arms 17′ are maintained in a spaced apart relation to one another by a header 14′. In addition, one or more weight 18′ is provided on the end of the arms 17′ of the agitator 16′.

In an example, the weights 18′ may balance the agitator when the device is used at or near the surface of the water.

In another example, the weights 18′ help the agitator 16′ sink to a desired depth in the water. This may assist in keeping the agitator 16′ from floating on the surface of the water, as might otherwise happen if any of the supply line (not shown in FIG. 3), the header 14′, and/or the agitator 16′ are made of materials that are less dense than water, or if the materials when filled with air or gas are less dense than water.

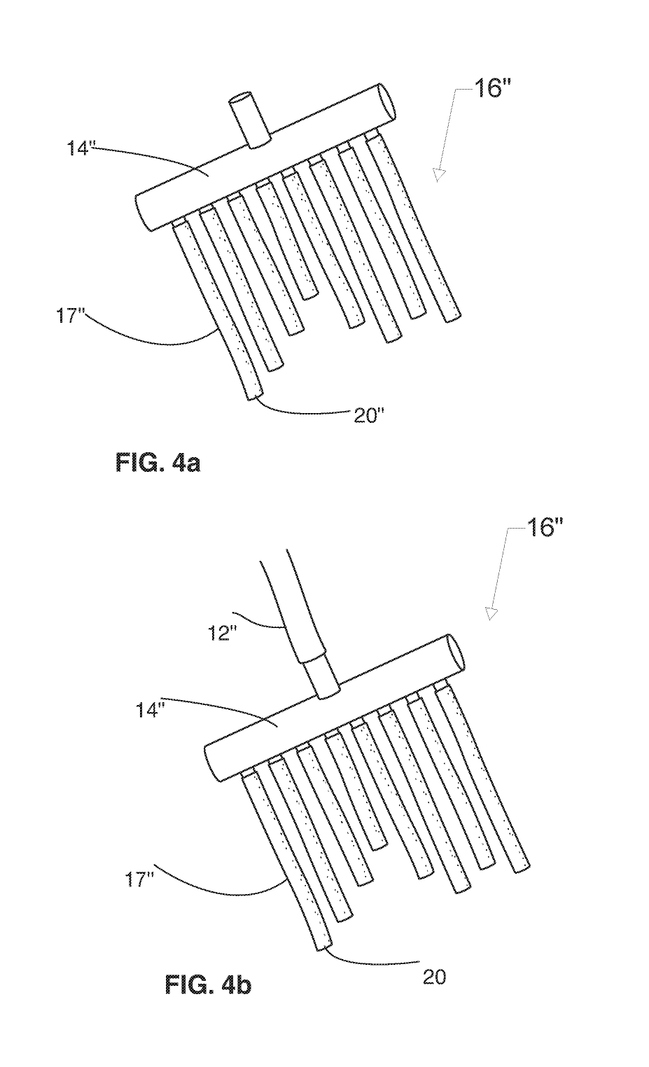

FIGS. 4a and 4b show an example device 10″ for attracting aquatic and marine life, with end caps 20″ on the ends of the agitator 16″. Similar components are shown in FIGS. 4a and 4b with double prime (″) reference numbers, and correspond to the reference numbers already described above for FIGS. 1 and 2.

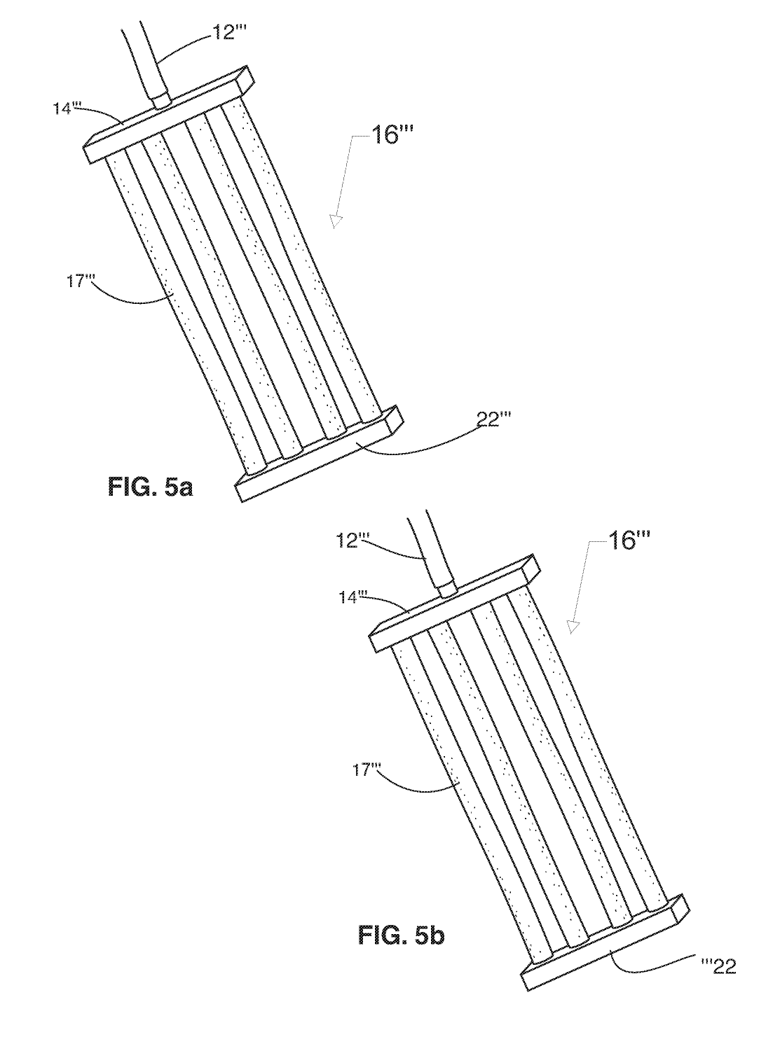

FIGS. 5a and 5b show an example device 10′″ for attracting aquatic and marine life, with a manifold 22′″. Similar components are shown in FIGS. 5a and 5b with triple prime (′″) reference numbers, and correspond to the reference numbers already described above for FIGS. 1 and 2.

In this example, the agitator 16′ includes a manifold 14′″ on each end. The manifold 14′ and/or arms 17 may include openings which distribute air, gas, and/or fluid into the water.

Still other examples are also contemplated. For example, a design choice may include a fitting to attach additional supply line(s), agitator(s), arm(s), adaptors, splitters, or diffusers to the device. In another example, lighting (e.g., LED lights) may also be provided to enhance the fish attractant device for certain types of fish and/or time of use (e.g., day versus night) and/or conditions (e.g., dark or deep water).

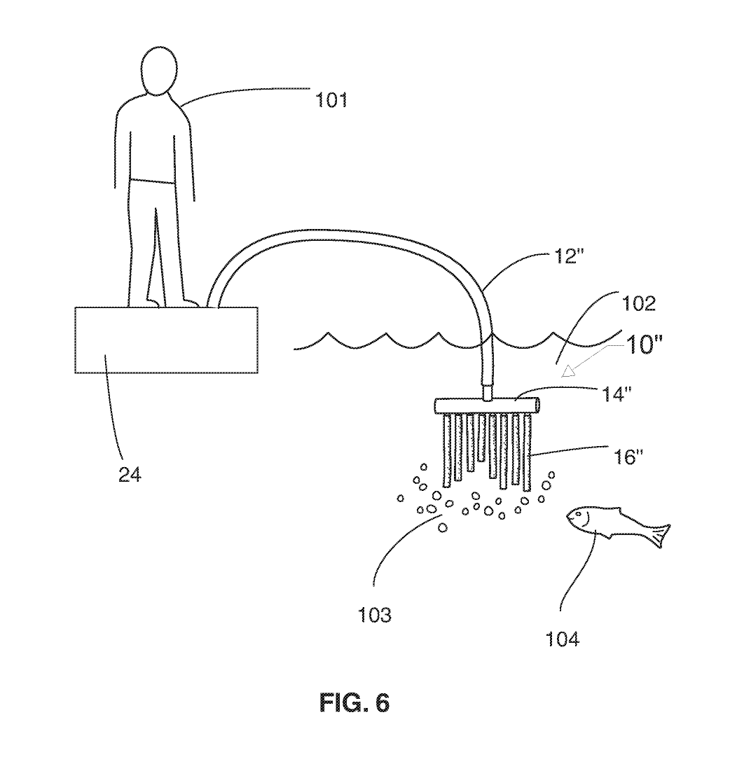

FIG. 6 illustrates a person implementing an example device for attracting aquatic and marine life. In this illustration, a person 101 is using an example device (e.g., device 10″ described above for FIGS. 4a and 4b) for attracting aquatic and marine life 104.

The person 101 is operating the hose or supply line 12″, which may be attached to a pump assembly 24 that feeds air or gas into the supply line 12″. The air or gas then flows through the supply line 12″ and into the head 14″, where it is distributed into the agitator or diffuser 16″.

Since the diffuser 16″ is located above the surface, just under the surface, or deeper under the surface of a body of water 102, the released air or gas takes the form of bubbles 103, which form a disturbance in the water 102. This disturbance may attract fish or other aquatic or marine life 104.

A similar pump assembly 24 (not pictured) may be used to draw water from the body of water 102 and return it via the agitator 16, creating a disturbance in the water without bubbles 103.

As will be readily appreciated by those having ordinary skill in the art after becoming familiar with the teachings herein, not all aquatic life forms 104 will react identically to a disturbance in the water. In an example, there is a threshold gas or fluid flow value below which a desired form of aquatic life 104 does not notice or is not attracted by the disturbance, and a threshold value above which the desired aquatic life form 104 is frightened or repelled by the disturbance. In this example, a control mechanism (e.g., a dial) on the pump assembly 24 may be employed to keep the gas or fluid flow in a range where desired aquatic life forms 104 are attracted to the disturbance.

The pump assembly 24 may also include other control options such as the rate and amplitude of a variation in gas flow, and/or the spacing and duration of pauses in the gas flow, that may be of value in attracting particular types of aquatic life. For example, the airflow (or other gas or liquid) may be controlled to simulate a pattern of sounds or vibrations emitted by a feeding frenzy of that particular species, or a related species, or a prey species. Such options may be controlled by a microcontroller and selected via a touchscreen interface.

It is noted that other methods of control may also be employed. For example, output of the air or other gas, and/or liquid may be controlled by a mechanical device. Output of the mechanical device may be manually selected with a control panel including, for example, appropriate dials, switches, and sliders.

In an example, the pump assembly 24 may be actuated by a generator or battery, to power an air compressor or pump that is attached to the supply line, e.g., located on the side of a watercraft, dock, beach, commercial fishing vessel, etc. The agitator pushes air, gas, and/or fluid into a body of water to create the feeding frenzy effect. The pump assembly may also be powered by a photovoltaic array, combustion engine, grid power, or other power sources.

In another example, the pump assembly comprises a manually operated foot pump, hand crank pump, lever pump, siphon pump, plunger pump, or piston pump whose force and rhythms are determined by the operator. In this case, the operator may develop particular manual techniques for operating the pump so as to attract different species of fish or other aquatic life. Such an arrangement may be of particular value in developing countries where capital, power, and fuel may be scarce or prohibitively expensive.

The elements, operations, and arrangements shown and described herein are provided to illustrate example implementations. It is noted that the operations are not limited to the ordering shown. Still other examples may also be implemented. In an example, the agitator may not comprise straight pipes or hoses as shown in the figures, but of curved or coiled hoses. The supply of air or gas may come from a tank or other reservoir of compressed air or gas rather than a pump assembly.

In another example, the device may include a motor (e.g., a cell phone vibrator operated by an appropriately sized battery) in addition, or instead of the air/gas/liquid output. The motor may be operated to vibrate a metal or other object in the water (e.g., a motor that can be added inside the lines or coils of the agitator). In an example, the motor may be controlled via a microcontroller that provides numerous options of motor control, speed, etc. via a simple transistor and/or other circuitry).

Fish react to vibration, and different fish sense different vibrations depending on their own characteristics, and those of their prey. Whether the disturbance is caused by output of air or other gas and/or fluid, and/or a vibration, the output of the agitator may be controllable via a controller to control at least one of amplitude of the disturbance, period of the disturbance, interval of the disturbance, pauses in the disturbance, and duration of the disturbance.

It is noted that the examples shown and described are provided for purposes of illustration and are not intended to be limiting. Still other examples are also contemplated.

1. A device for attracting aquatic and marine life, comprising:
a head coupled to a supply line to provide gas and/or liquid to the head; and
an agitator coupled to the head, the agitator configured to output the gas and/or liquid into a body of water and cause a disturbance in the body of water in a manner that attracts desired species of aquatic and marine life.

2. The device of claim 1, wherein the actuator includes at least one arm having at least one opening to output the gas and/or liquid into the body of water.

3. The device of claim 1, wherein the actuator includes a plurality of arms having a plurality of openings to output the gas and/or liquid into the body of water.

4. The device of claim 3, wherein the plurality of arms are automatically spread open when the gas and/or liquid is discharged through the plurality of openings in the arms.

5. The device of claim 3, wherein the plurality of arms are substantially the same length.

6. The device of claim 3, wherein the plurality of arms are different length from one another.

7. The device of claim 3, further comprising a manifold on at least one end of the plurality of arms.

8. The device of claim 3, further comprising a manifold on each end of the plurality of arms.

9. The device of claim 3, further comprising a weight on one end of the plurality of arms.

10. The device of claim 1, further comprising a vibrating element in association with the agitator.

11. A device for attracting aquatic and marine life, comprising:
a head coupled to a supply line to provide gas and/or liquid to the head; and
an agitator coupled to the head;
a plurality of arms of the agitator, the plurality of arms having a plurality of openings therein to output the gas and/or liquid into a body of water and cause a disturbance in the body of water in a manner that attracts desired species of aquatic and marine life.

12. The device of claim 11, wherein the plurality of arms are automatically spread open when the gas and/or liquid is discharged through the plurality of openings in the arms.

13. The device of claim 11, wherein the plurality of arms are different lengths from at least one of the plurality of arms.

14. The device of claim 11, wherein the plurality of arms are substantially the same length.

15. The device of claim 11, further comprising a manifold on at least one end of the plurality of arms.

16. The device of claim 11, further comprising a manifold on each end of the plurality of arms.

17. The device of claim 11, further comprising a weight on one end of the plurality of arms.

18. The device of claim 11, further comprising a vibrating element in association with the agitator.

19. A device for attracting aquatic and marine life, comprising:
a head coupled to a supply line to provide gas and/or liquid to the head; and
an agitator coupled to the head;
a plurality of arms of the agitator, the plurality of arms having a plurality of openings therein to output the gas and/or liquid into a body of water and cause a disturbance in the body of water in a manner that attracts desired species of aquatic and marine life.

20. The device of claim 19, wherein output of the agitator is controllable as to at least one of amplitude of the disturbance, period of the disturbance, interval of the disturbance, pauses in the disturbance, and duration of the disturbance.
